(19) United States
(12) Patent Application Publication
(10) Pub. No.: US 2023/0103116 A1
(43) Pub. Date: Mar. 30, 2023

(54) CONTENT UTILIZATION PLATFORM SYSTEM AND METHOD OF PRODUCING AUGMENTED REALITY (AR)-BASED IMAGE OUTPUT

(71) Applicant: THES Co., Ltd., Daejeon (KR)

(72) Inventor: Mingu Lee, Daejeon (KR)

(21) Appl. No.: 17/489,076

(22) Filed: Sep. 29, 2021

(30) Foreign Application Priority Data
Sep. 24, 2021 (KR) 10-2021-0126475

(51) Int. Cl. G06K 9/00; H04N 21/24; H04N 21/4784; H04N 21/478; H04N 21/442; G06T 7/73

(52) U.S. Cl. CPC G06K 9/00335; H04N 21/2407; H04N 21/4784; H04N 21/4781; H04N 21/44218; G06T 7/73

(57) ABSTRACT

Provided is a content utilization platform system including an image production device configured to produce and output an image output by applying augmented reality (AR) content to a captured subject; a server configured to extract AR content based on at least one of the number of users, ticket information, viewing information, reservation information, and a subject image, to provide the extracted AR content to the image production device, to receive an image produced by the image production device from the image production device, and to provide a virtual space using the produced image; and a user terminal configured to connect to the virtual space provided from the server.

### CROSS-REFERENCE TO RELATED APPLICATION(S)

This application claims priority to Korea Patent Application No. 10-2021-0126475, filed on Sep. 24, 2021, the content of which is incorporated by reference in its entirety.

### FIELD OF THE INVENTION

Example embodiments relate to a content utilization platform system and a method of producing an augmented reality (AR)-based image output.

### DESCRIPTION OF THE RELATED ART

Currently, there is an increasing interest in the field of enhancing business feasibility using various types of contents. For example, beyond simply providing a video or holding a performance using a movie, an animation, a performance, a concert, and a character, a character appearing in a corresponding movie, animation, or performance or an artist of a concert may be used to sell goods or a social network service (SNS) or a video channel may be used to enter a field that generate continuous revenues.

As one of such cases, there is a photo ticket. The photo ticket refers to a ticket that is printed by inserting an image of a specific photo and the like. A conventional ticket describes only information about a movie or a performance that is the purpose of the ticket. To provide various services and publicity, a form of the ticket has been diversified and contents included in the ticket have also been enriched. The publicity plays a very important role in the cultural industry and more diverse services than before are required. Considering such characteristics of the industrial field, the photo ticket is playing a role as one of creative promotion methods in various fields.

The photo ticket may be produced in such a manner that a user inserts a desired image in a reservation stage or may be produced using a photo ticket creation program after the user views a movie or a performance. Currently, the photo ticket may be produced by directly capturing and inserting an image through a photo ticket production device on the spot.

Augmented reality (AR) refers to technology for augmenting and thereby providing information based on reality and also refers to technology for displaying an image in which a virtual image is added to a real image. The AR technology is compared to virtual reality (VR) technology for configuring and displaying all images provided in VR as a virtual image. Currently, AR-related technology is used in various fields, such as, for example, a navigation system and a shooting screen.

Face alignment technology refers to technology for recognizing and tracking a facial image. That is, the face alignment technology refers to technology for training a plurality of face databases using an artificial intelligence (AI) system and estimating a location of a feature point in a face and extracting the feature point from the face based on the trained databases.

As such, technologies using a movie, an animation, a concert, a character, and the like, are increasing, but still being used in limited technical fields.

Accordingly, there is a need for a content utilization platform system that may provide a user with a new way of pleasure using various types of contents and may also continuously utilize content that is a creation of cost, time, and effort from a point of view of a creator.

### SUMMARY OF THE INVENTION

At least one example embodiment provides a content utilization platform system that may provide a user with a new way of pleasure using various types of contents and may also continuously utilize content that is a creation of cost, time, and effort from a point of view of a creator, and a method of producing an augmented reality (AR)-based image output.

The aforementioned objects and other objects of the present disclosure may be achieved by the following example embodiments.

According to an aspect of at least one example embodiment, there is provided a content utilization platform system.

The content utilization platform system includes a server configured to extract AR content based on at least one of the number of users, ticket information, viewing information, reservation information, and a subject image, to provide the extracted AR content to an image production device, to receive an image produced by the image production device from the image production device, and to provide a virtual space using the produced image to a user terminal; the image production device configured to produce and output an image output by applying AR content to a captured subject; and the user terminal configured to connect to the virtual space provided from the server.

The server may include at least one of an AR content provider configured to provide AR content to the image production device; a virtual space provider configured to provide the virtual space accessible by a user to the user terminal; a user database configured to store and manage at least one of user information and an authentication code; a payment unit configured to perform a payment from the user; a survey manager configured to request at least one of the image production device and the user terminal for survey; an event manager configured to provide a coupon and a product to at least one of the image production device and the user terminal; and a communicator configured to perform at least one of wired communication and wireless communication with the image production device and the user terminal.

The AR content provider may include at least one of an AR database configured to store and manage AR content provided from at least one of a content creator and the user; and an AR content recommender configured to extract AR content based on at least one of the number of users, ticket information, viewing information, reservation information, and a subject image, and to provide the extracted AR content to the image production device.

The AR content recommender may be configured to provide an additional AR image according to a motion and a gesture of a subject recognized by a motion recognition sensor.

The virtual space provider may include at least one of a quiz field that enables at least one user connected to the virtual space to solve a quiz and receive a corresponding reward; an item field that enables the user connected to the virtual space to purchase at least one of an item and a product related to content; and an actor field that enables the user connected to the virtual space to communicate with a content-related person or to view an image or a video provided from the content-related person.

The image production device may include at least one of a communicator configured to perform at least one of wired communication and wireless communication with the server; a sensor unit configured to recognize a subject; an input unit configured to receive information and a request from a user; a capturing unit configured to capture the subject; a display unit configured to display a shooting screen and an output screen on which the subject and AR content appear; and an output unit configured to produce and output an image output by inserting an image captured by applying the AR content.

The sensor unit may include at least one of a human body sensor configured to recognize approach of the subject; and a motion recognition sensor configured to recognize a motion and a gesture of the subject.

The image production device may be configured to set a subject to be captured among subjects detected through the sensor unit, to extract AR content from a database based on at least one of the number of users, ticket information, viewing information, and reservation information, to analyze a gesture and a capturing direction of the subject to be captured, apply AR content that matches the gesture of the subject to be captured based on an analysis result in consideration of the capturing direction of the corresponding subject, and provide the same to the shooting screen, to produce and output an image output by inserting an image captured by applying AR content selected from the user, to extract a landmark feature point related to a body part including a face and a hand of the subject to be captured, recognize and track the subject to be captured in real time based on the landmark feature point, and automatically adjust a size of the AR content based on a size of the subject to be captured, in response to the user viewing a specific movie and inputting ticket information, to extract AR content related to the specific movie, to automatically match and recommend AR content based on subject analysis information including at least one of a location, a facial expression, and a gesture of the subject to be captured, in response to applying the AR content related to the specific movie to the subject to be captured, to apply AR content corresponding to a character or a background screen of the specific movie to a subject to not be captured among the subjects detected through the sensor unit, and to distinguish the subject to be captured from the subject to not be captured based on a screen occupation area.

The user terminal may include at least one of a communicator configured to perform at least one of wired communication and wireless communication with the server; an input unit configured to receive information and request from a user; a user content provider configured to provide AR content produced by the user to the server; and a display unit configured to display the virtual space and contents required for communication with the server.

According to an aspect of at least one example embodiment, there is provided a method of producing an AR-based image output.

The method of producing the AR-based image output using an image production device configured to produce an image output in the content utilization platform system includes initiating capturing; setting a subject to be captured among subjects detected through a sensor unit; extracting AR content from a database based on at least one of the number of users, ticket information, viewing information, and reservation information; analyzing a gesture and a capturing direction of the subject to be captured, applying AR content that matches the gesture of the subject to be captured based on an analysis result in consideration of the capturing direction of the corresponding subject, and providing the same to a shooting screen; and producing and outputting an image output by inserting an image captured by applying AR content selected from a user, wherein the providing to the shooting screen includes extracting a landmark feature point related to a body part including a face and a hand of the subject to be captured, recognizing and tracking the subject to be captured in real time based on the landmark feature point, and automatically adjusting a size of the AR content based on a size of the subject to be captured; in response to the user viewing a specific movie and inputting ticket information, extracting AR content related to the specific movie; automatically matching and recommending AR content based on subject analysis information including at least one of a location, a facial expression, and a gesture of the subject to be captured; in response to applying the AR content related to the specific movie to the subject to be captured, applying AR content corresponding to a character or a background screen of the specific movie to a subject to not be captured among the subjects detected through the sensor unit; and distinguishing the subject to be captured from the subject to not be captured based on a screen occupation area.

The initiating of the capturing may include in response to recognizing a random subject by a specific size or more in a capturing area, displaying a screen on which AR content is applied to the random subject and outputting a sound.

The extracting of the AR content may include recognizing and analyzing an age, a gender, a facial expression, and a gesture of a subject by applying artificial intelligence (AI) technology based on a pretrained database, and automatically matching and recommending AR content based on an analysis result.

The producing and outputting of the image output may include creating a plurality of images; distributing the plurality of images on an output area; and setting a type of the image output.

According to some example embodiments, there may be provided a content utilization platform system that may provide a user with a new way of pleasure using various types of contents and may also continuously utilize content that is a creation of cost, time, and effort from a point of view of a creator, and a method of producing an AR-based image output.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

These and/or other aspects, features, and advantages of the invention will become apparent and more readily appreciated from the following description of embodiments, taken in conjunction with the accompanying drawings of which:

FIG. 1 illustrates an example of a content utilization platform system according to an example embodiment;

FIG. 2 is a block diagram illustrating an example of an image production device according to an example embodiment;

FIG. 3 is a block diagram illustrating an example of a server according to an example embodiment;

FIG. 4 illustrates an example of (a) a quiz field, (b) an item field, and (c) an actor field according to an example embodiment;

FIG. 5 is a block diagram illustrating an example of a user terminal according to an example embodiment;

FIG. 6 illustrates photos corresponding to examples of a motion and a gesture of a user according to an example embodiment;

FIG. 7 illustrates an example of simply describing gamification content according to an example embodiment;

FIG. 8 is a flowchart illustrating an example of a method of producing an augmented reality (AR)-based image output according to an example embodiment;

FIG. 9 is a flowchart illustrating an example of an operation of performing capturing by applying AR content in the method of producing the AR-based image output according to an example embodiment;

FIG. 10 illustrates examples of images before and after applying AR content according to an example embodiment;

FIG. 11 illustrates examples of images to which AR content is applied when a plurality of subjects is present according to an example embodiment;

FIG. 12 illustrates examples of images before and after applying AR content when a capturing direction of a subject corresponds to a side view according to an example embodiment;

FIG. 13 illustrates an example of outputting an image by inserting and combining a plurality of images in separate areas according to an example embodiment; and

FIG. 14 illustrates an example of inserting images on a front surface and a rear surface of an image output, respectively, according to an example embodiment.

### DETAILED DESCRIPTION OF THE INVENTION

One or more example embodiments will be described with reference to the accompanying drawings. Advantages and features of the example embodiments, and methods for achieving the same may become explicit by referring to the accompanying drawings and the following example embodiments. Example embodiments, however, may be embodied in various different forms, and should not be construed as being limited to only the illustrated embodiments.

Rather, the illustrated embodiments are provided as examples so that this disclosure will be thorough and complete, and will fully convey the concepts of this disclosure to those skilled in the art. Sizes of components, such as widths, thicknesses, etc., may be exaggerated to clearly represent the components of each device in the drawings. Also, although only a portion of the components are illustrated for clarity of description, one of ordinary skill in the art may easily verify the remaining components.

When an element is referred to as being on or below another element, the element may be directly on or below the other element or an intervening element may be present between the elements. Also, one of ordinary skill in the art may embody the spirit of the present application in various forms without departing from the scope of technical spirit. Unless otherwise noted, like reference numerals refer to like elements throughout the attached drawings and written description, and thus descriptions will not be repeated.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, components, elements, and/or combinations thereof, but do not preclude the presence or addition of one or more other features, integers, steps, components, elements, and/or combinations thereof.

Also, “X to Y” representing the range indicates “greater than or equal to X and less than or equal to Y.”

Herein, the term “˜unit” includes a unit implemented by hardware, a unit implemented by software, and a unit implemented using hardware and software. Also, a single unit may be implemented using two or more pieces of hardware and two or more units may be implemented using a single piece of hardware. Meanwhile, “˜unit” is not limited to software or hardware and may be configured in an addressable storage medium and may be configured to reproduce one or more processors. Therefore, for example, “˜unit” may include components, such as software components, object-oriented software components, class components, and task components, processes, functions, attributes, procedures, sub-routines, segments of a program code, drivers, firmware, a microcode, a circuit, data, database, data structures, tables, arrays and variables. Functions provided from the components and “˜units” may be coupled with a smaller number of components and “˜units” or may be further divided into additional components and “˜units.” In addition, the components and “˜units” may be implemented to reproduce one or more central processing units (CPUs) in a device or a secure multimedia card.

Also, the term “network” may be implemented using wired networks, such as, for example, a local area network (LAN), a wide area network (WAN), and a value added network (VAN), and any type of wireless networks, such as, for example, a mobile radio communication network and a satellite communication network.

The term “image output” used herein refers to an output in which an image desired by a user is inserted with information about, for example, a movie or a performance that is the purpose of a ticket. The “image output” may include, for example, a photo ticket and, without being limited thereto, include any type of an output in which an image is inserted and output, for example, printed.

The term “subject” used herein refers to an entity to be captured, such as a user, when capturing an image to be inserted into an image output or a third entity included in a shooting screen. The term “augmented reality (AR) content” used herein refers to content that is inserted into an image based on AR technology. The AR content may be content related to a movie or a performance that is the purpose of a ticket, however, without being limited thereto, may include any type of contents. The term “main content 41” used herein refers to AR content that is applied to a subject specified as a user. The term “sub content 43” refers to AR content that is applied to a subject not specified as a user. The term “capturing area” refers to a space that allows capturing using an electronic device used to capture an image. For example, when the electronic device is a camera with an AR function, the capturing area may refer to a space within a few meters from a corresponding camera lens. The term “capturing direction” refers to a direction in which a user is standing in front of an electronic device for capturing. For example, the user may face the electronic device from the front and the left side or the right side of the user may face the electronic device as the side of the user. The term “lenticular” refers to technology that allows a flat image to be viewed as a three-dimensional (3D) image or a different image depending on a viewing angle through 3D graphic technology. The term “landmark feature point” refers to an element that is a feature to identify a portion of a body of a subject, such as, for example, a face and a hand, or a whole of the subject.

Content Utilization Platform System

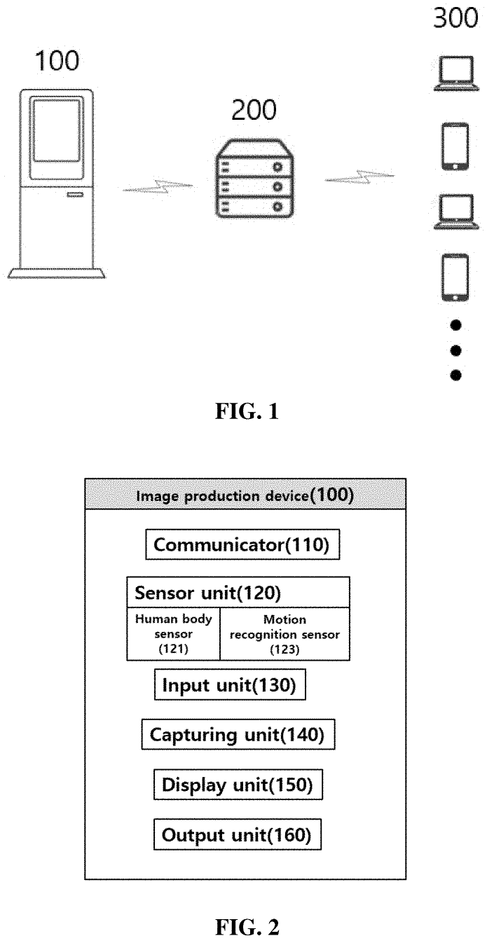

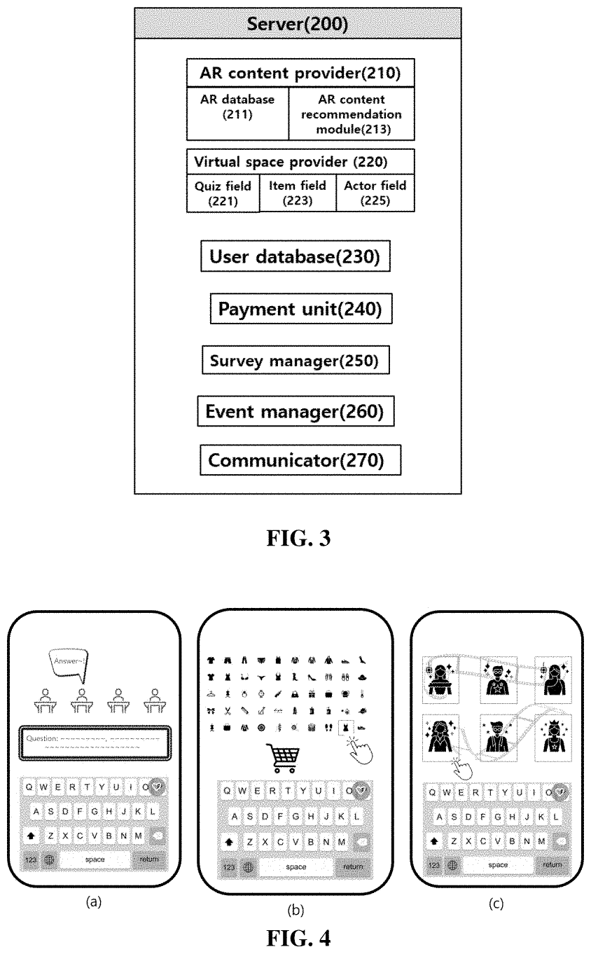

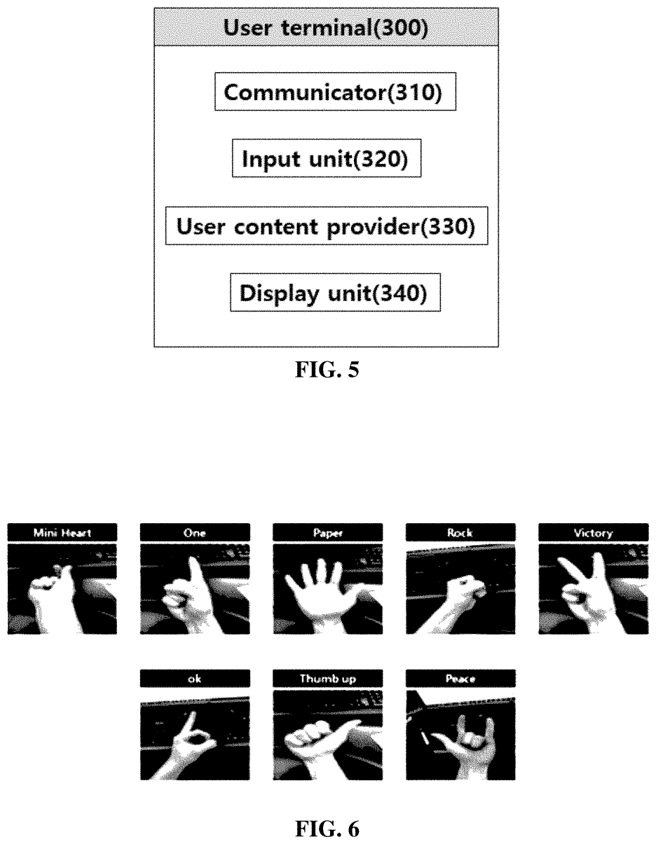

Hereinafter, a content utilization platform system according to an example embodiment is described with reference to FIGS. 1 to 5. FIG. 1 illustrates an example of a content utilization platform system according to an example embodiment, FIG. 2 is a block diagram illustrating an example of an image production device according to an example embodiment, FIG. 3 is a block diagram illustrating an example of a server according to an example embodiment, FIG. 4 illustrates an example of (a) a quiz field, (b) an item field, and (c) an actor field according to an example embodiment, and FIG. 5 is a block diagram illustrating an example of a user terminal according to an example embodiment.

According to an example embodiment, the content utilization platform system includes a server 200 configured to extract AR content based on at least one of the number of users, ticket information, viewing information, reservation information, and a subject image, to provide the extracted AR content to an image production device 100, to receive an image produced by the image production device 100 from the image production device 100, and to provide a virtual space using the produced image to a user terminal 300; the image production device 100 configured to produce and output an image output by applying AR content to a captured subject; and the user terminal 300 configured to connect to the virtual space provided from the server 200.

The server 200 may include at least one of an AR content provider 210 configured to provide AR content to the image production device 100; a virtual space provider 220 configured to provide the virtual space accessible by a user to the user terminal 300; a user database 230 configured to store and manage at least one of user information and an authentication code; a payment unit 240 configured to perform a payment from the user; a survey manager 250 configured to request at least one of the image production device 100 and the user terminal 300 for survey; an event manager 260 configured to provide a coupon and a product to at least one of the image production device 100 and the user terminal 300; and a communicator 270 configured to perform at least one of wired communication and wireless communication with the image production device 100 and the user terminal 300.

The AR content provider 210 serves to extract AR content based on information at least one of the number of users, ticket information, viewing information, reservation information, and a subject image, and to provide the extracted AR content to the image production device 100. In detail, when the user views a specific movie and inputs ticket information, the AR content provider 210 may extract AR content related to the specific movie and may automatically match and recommend the AR content based on subject analysis information including at least one of a location, a facial expression, and a gesture of a subject that is a target to be captured (hereinafter, a subject to be captured).

The AR content provider 210 may include at least one of an AR database 211 configured to store and manage AR content provided from at least one of a content creator and the user; and an AR content recommendation module 213 configured to extract AR content based on information at least one of the number of users, ticket information, viewing information, reservation information, and a subject image, and to provide the extracted AR content to the image production device 100.

The AR content recommendation module 213 may also provide an additional AR image according to a motion and a gesture of a subject recognized by a motion recognition sensor that is provided to the image production device 100. In detail, the subject image may include, for example, size information, direction information, and angle information of the subject. Referring to FIG. 6, the motion and the gesture of the subject may be a preset and thereby input image, such as, for example, hand heart such as mini heart, one, paper, rock, victory, ok, thumb up, and peace. The additional AR image provided according to the motion and the gesture may be mini heart, glasses, large thumb up, cap, hair, and cosmetics. However, it is provided as an example only.

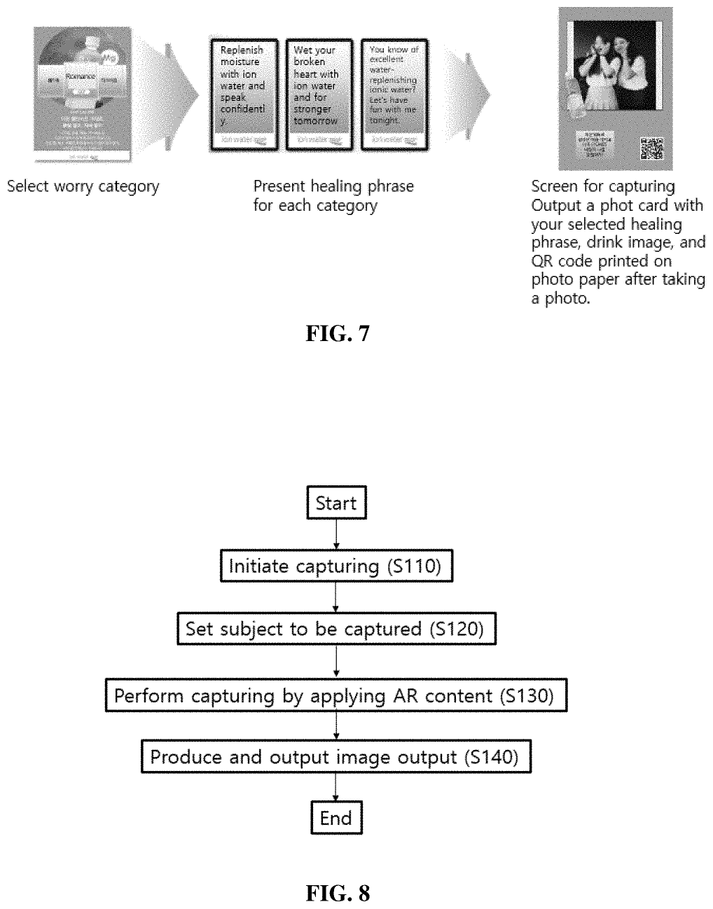

According to another example embodiment, the AR database 211 may store gamification-related content, and the AR content recommendation module 213 may extract and provide the gamification-related content. In detail, the image production device 100 may provide an answer, a phrase, and the like related to a category selected from the user as content. Referring to FIG. 7, the gamification-related content may include a trouble category and an answer, a healing phrase, and the like related thereto may be provided to the image production device 100 as AR content.

The AR content provided from the AR content provider 210 to the image production device 100 may be applied to a subject captured by the image production device 100, and an image produced, that is, created as above may be provided again to the server 200 with user information and an authentication code.

The virtual space provider 220 may provide the virtual space using the image produced by the image production device 100 to the user terminal 300 for access of the user. The produced image may be represented in a character of the user in the virtual space, may be stored in a storage box or a wallet in the virtual space to be verified by the user or to be displayed for another user, or may be displayed on the character.

In detail, when the user terminal 300 is connected to the virtual space, the user terminal 300 may be connected to the character of the user based on the user information and a movable or accessible field (or area or category) in the virtual space may be determined based on the authentication code.

For example, referring to FIG. 4, the virtual space provider 220 may include at least one of a quiz field 221 ((a) of FIG. 4) that enables at least one user connected to the virtual space to solve a quiz and receive a corresponding reward; an item field 223 ((b) of FIG. 4) that enables the user connected to the virtual space to purchase at least one of an item and a product related to content; and an actor field 225 ((c) of FIG. 4) that enables the user connected to the virtual space to communicate with a content-related person or to view an image or a video provided from the content-related person.

The quiz field 221, the item field 223, and the actor field 225 accessible based on the authentication code may be determined. For example, after viewing movie A, the user may input movie A information and user information into the image production device 100 to produce and output an image, and the produced image may be provided to the server 200 with the user information and the authentication code. Here, the authentication code may be a code that authenticates viewing of the movie A. The user may be connected to the virtual space including the quiz field 221, the item field 223, and the actor field 225 related to the movie A based on the authentication code through the user terminal 300. It may be applied to a concert, a sports venue, a museum, a fan meeting, a corporate brand event, a theme parks, and a tourist attraction spot as well as movie. In this case, the actor field 225 of the virtual space may variously include singers, sports stars, exhibits, and entertainers.

In detail, the quiz field 221 may include quizzes (mania authentication quizzes) of which a user having experienced a movie, a concert, a sports venue, a museum, a fan meeting, a corporate brand event, a theme park, and a tourist attraction spot related to a corresponding authentication code may be aware for at least one user. Here, if the number of users is two or more, the users may compete and the event manager 260 may provide a coupon and the like to the user as a reward.

In detail, the item field 223 may allow the user to purchase an actual product and an item applicable to the virtual space in relation to the movie, the concert, the sports venue, the museum, the fan meeting, the corporate brand event, the theme park, and the tourist attraction spot related to the authentication code. The item may be represented on a character of the user in the virtual space, may be stored in a storage box or a wallet in the virtual space to be verified by the user or to be displayed for another user, or may be displayed on the character. Here, the payment unit 240 of the server 200 may make a payment for cost through the user terminal 300.

In detail, the actor field 225 may allow the user to view an image or a video related to a person, a work, or a building related to the movie, the concert, the sports venue, the museum, the fan meeting, the corporate brand event, the theme park, and the tourist attraction spot related to the authentication code. When the actor field 225 relates to a person, the user may communicate with the corresponding person on a preset date and time, which may motivate the user.

The user database 230 may store and manage at least one of user information, an authentication code, and a produced image that are provided from the image production device 100 for each user. The user information may include at least one of a gender, an age, a mobile phone number, and a field of interest. The authentication code relates to movie information, sports venue information, concert information, tour attraction spot information, museum information, fan meeting information, corporate brand information, and theme park information input from the user to the image production device 100 and may authenticate that the user has viewed and visited a corresponding place.

The payment unit 240 may pay for cost using the image production device 100 and may receive a payment from the user through connection and communication with the image production device 100. Any payment method easily applicable by those skilled in the art may be applied.

The survey manager 250 may provide a survey related to the movie, the concert, the sports venue, the museum, the fan meeting, the corporate brand event, the theme park, and the tourist attraction spot to the image production device 100 or the user terminal 300 and may collect information from the user. Also, the survey manager 250 may provide a survey related to AR content provided from the server 200 to the image production device 100 or the user terminal 300 and may collect information from the user.

The event manager 260 may transmit an event or a coupon provided from the movie, the concert, the sports venue, the museum, the fan meeting, the corporate brand event, the theme park, and the tourist attraction spot to the image production device 100 or the user terminal 300 and may notify or provide the same to the user. Also, the event manager 260 may transmit the event or the coupon related to the AR content provided from the server 200 to the mage production device 100 or the user terminal 300 and may notify or provide the same to the user.

The communicator 270 may perform wired/wireless communication with the image production device 100 or the user terminal 300.

The image production device 100 may include at least one of a communicator 110 configured to perform at least one of wired communication and wireless communication with the server 200; a sensor unit 120 configured to recognize a subject; an input unit 130 configured to receive information and a request from a user; a capturing unit 140 configured to capture the subject; a display unit 150 configured to display a shooting screen and an output screen on which the subject and AR content appear; and an output unit 160 configured to produce and output an image output by inserting an image captured by applying the AR content.

The communicator 110 may perform wired and wireless communication with the server 200.

The sensor unit 120 may include at least one of a human body sensor 121 configured to recognize approach of the subject; and a motion recognition sensor 123 configured to recognize a motion and a gesture of the subject.

The human body sensor 121 may determine whether the subject or the user is approaching the image production device 100, and the motion recognition sensor 123 may recognize and analyze a motion and a gesture of the subject or the user, a capturing direction in which the subject or the user is captured, and the like, and may generate information related thereto, and may transmit the generated information to the server 200 through the communicator 110.

According to another example embodiment, the sensor unit 120 may include an iris recognition sensor (not shown) configured to detect and analyze an iris of a subject.

The input unit 130 may receive, from the user, the number of users, ticket information, viewing information, reservation information, user information, and information for using the image production device 100. A method of receiving information from a user may include an input through a physical button, an input through a touchscreen, an input through a quick response (QR) code or a barcode scan, and the like. However, it is provided as an example only.

The capturing unit 140 may include a camera with an AR function of capturing the subject or the user or a lenticular camera. However, it is provided as an example only.

The camera with the AR function refers to a camera to which face alignment technology for recognizing and tracking a body part, such as a face of the subject, is applied and capable of applying AR content on the shooting screen.

The lenticular camera refers to a camera with a plurality of lenses for taking a lenticular photo.

According to an example embodiment, the capturing unit 140 may include an AR image processing module (not shown). The AR image processing module may perform capturing by applying prestored AR content to at least one subject. Here, the AR image processing module serves to extract a landmark feature point related to a body part including a face and a hand of the subject, to recognize and track the subject in real time based on the landmark feature point, and to automatically adjust a size of the AR content based on a size of the subject. The capturing unit 140 may extract a feature of the subject and may set and store the extracted feature in the AR image processing module. The AR image processing module may be configured independently from the capturing unit 140.

According to another example embodiment, AI technology, machine learning technology, and deep learning technology may apply to the AR image processing module. In detail, for example, the AR image processing module may automatically recognize and analyze information (e.g., an age, a gender, a race, a motion, etc.) about a subject based on a prestored database and a trained database without receiving the information from the subject. As another example, the AR image processing module may automatically match and recommend AR content based on analysis information about a subject, such as a location, a facial expression, and a gesture of the subject. The display unit 150 serves to display the shooting screen and the output screen on which the subject and the AR content appear. Through the display unit 150, the user may verify the shooting screen and may perform image capturing, may verify an image to be output in advance, and proceed with an output stage.

The display unit 150 may be a display.

The output unit 160 may be a printer configured to output an image produced by the image production device 100 as a real object. However, it is provided as an example only. In detail, a variety of technology may apply depending on a type of an image output that is output from the output unit 160. For example, in the case of outputting an image output in a form of a lenticular card, the output unit 160 may include a lenticular film and equipment for outputting the same.

A type of the image output may include a plastic card, paper, thermal image paper, and a lenticular card, and, without being limited thereto, may include any type of materials capable of inserting and thereby outputting an image. Also, the image output may be provided in a mobile content form as well as in a physical output form.

In detail, for example, the image production device 100 may include a controller (not shown). The controller may extract a landmark feature point related to a body part including a face and a hand of the subject, may recognize and track the subject in real time based on the landmark feature point, and may automatically adjust a size of the AR content based on a size of the subject, with data analysis and determination of the motion recognition sensor 123. Also, the controller may extract information required for the AR content recommendation module 213 of the server 200 to recommend content, such as, for example, a location, a facial expression, a gesture, a direction, and a size of the subject, movie information, sports venue information, concert information, tour attraction spot information, museum information, fan meeting information, corporate brand information, and theme park information, and may transmit the extracted information to the server 200. Also, the controller may apply AR content provided from the server 200 to an image to be captured by applying AR content corresponding to a character or a background screen of the specific movie or another image to a subject to not be captured among subjects detected through the sensor unit 120 and by distinguishing the subject to be captured from the subject to not be captured based on a screen occupation area.

For example, the image production device 100 may set a subject to be captured among subjects detected through the sensor unit 120, may extract AR content from a database based on at least one of the number of users, ticket information, viewing information, and reservation information, may analyze a gesture and a capturing direction of the subject to be captured, apply AR content that matches the gesture of the subject to be captured based on an analysis result in consideration of the capturing direction of the corresponding subject, and provide the same to the shooting screen, may produce and output an image output by inserting an image captured by applying AR content selected from the user, may extract a landmark feature point related to a body part including a face and a hand of the subject to be captured, recognize and track the subject to be captured in real time based on the landmark feature point, and automatically adjust a size of the AR content based on a size of the subject to be captured, may in response to the user viewing a specific movie and inputting ticket information, extract AR content related to the specific movie, may automatically match and recommend AR content based on subject analysis information including at least one of a location, a facial expression, and a gesture of the subject to be captured, may in response to applying the AR content related to the specific movie to the subject to be captured, apply AR content corresponding to a character or a background screen of the specific movie to a subject to not be captured among the subjects detected through the sensor unit, and may distinguish the subject to be captured from the subject to not be captured based on a screen occupation area.

The user terminal 300 may include at least one of a communicator 310 configured to perform at least one of wired communication and wireless communication with the server 200; an input unit 320 configured to receive information and request from a user; a user content provider 330 configured to provide AR content produced by the user to the server 200; and a display unit 340 configured to display the virtual space and contents required for communication with the server 200.

The user may access the virtual space provided from the server 200 through the user terminal 300 and may access various fields present in the virtual space based on the authentication code.

The content provider 300 may provide AR content directly customized by the user to the server 200. The customized AR content may be stored in the user database 230 or may be stored in the AR database 211 and provided to another user as AR content. Customized AR content with good reviews may be provided from the survey manager 250 to more users. The event manager 260 may provide a corresponding reward (e.g., a coupon) to the user.

Method of Producing an AR-Based Image Output

Hereinafter, a method of producing an AR-based image output is described with reference to FIGS. 8 to 14.

Referring to FIG. 8, the AR-based image output production method includes operation S110 of initiating capturing; operation S120 of setting at least one subject to be captured; operation S130 of performing capturing by applying AR content to the at least one subject; and operation S140 of producing and outputting an image output by inserting the image captured by applying the AR content.

Operation S110 refers to an operation in which the image production device 100 operates to produce an image output.

According to an example embodiment, the image production device 100 may directly receive an image output production request from a user.

Also, according to another example embodiment, although the user does not directly request the image production device 100 to produce an image output, the user may initiate to produce the image output by recognizing an approximate subject in the image output through a sensor and by displaying an image of the corresponding subject to which AR content is applied on a screen. Here, sound may be accompanied to draw an attention of the user. In detail, for example, when a random subject is recognized by a specific size or more in a capturing area, the image production device 100 may display a screen on which AR content is applied to the random subject and may output a sound to draw an attention. Through this, the image production device 100 may also serve as a method of promoting a specific service even for a user having not purchased a ticket.

Operation S120 refers to an operation of setting a subject to be captured among subjects detected through the sensor unit 120.

In general, when capturing a specific subject through an electronic device such as a camera, a plurality of subjects in addition to the specific subject may be included in a background and the like. Therefore, a target undesired by the user may be included, which may lead to degrading a satisfaction. In addition, nearby passersby may be included in the shooting screen regardless of their will, which may cause violation of portrait rights to occur. In addition, herein, when applying AR content, the AR content may be applied to an unnecessary target, which may cause inconvenience in creating a desired image. Therefore, it is very important to accurately set a subject to be captured.

In operation S120, the image production device 100 may receive information required to set the subject from the user.

The information may include the number of subjects, an age, a race, ticket information, viewing information, reservation information, a body part, a motion, and the like. However, it is provided as an example only. The input information is used as basic data to perform operation S133 of extracting the AR content to be applied in operation S130 of applying the AR content.

The server 200 receives the information through the image production device 100, and specifies, sets, and stores a subject based on the information. In this process, the capturing unit 140 recognizes and stores a feature (e.g., a landmark feature point) of a body to be distinguishable from another entity using face alignment technology. Here, the server 200 may be a server that is separately provided as shown in FIG. 1, or may be a server (not shown) that is additionally provided to the image production device 100.

For example, the capturing unit 140 may recognize a face of a user, may catch a feature, such as, for example, shapes of eyebrows, eyes, a nose, lips, and ears, skin tone, a length of hair, color of hair, and a facial proportion, and may store items that may be features.

Operation S130 refers to an operation of performing capturing through the capturing unit 140 by applying the AR content to a subject that appears on the shooting screen. Further description related thereto is made later.

Operation S140 refers to an operation of inserting an image captured and created through the previous operation into an image output and outputting and providing the image output in a user acquirable form.

In operation S140, the user may verify in advance the output screen through the display unit 150. Also, the user may select an image to be inserted from among created images. Here, a plurality of images may be inserted.

When the user determines to insert the plurality of images, the user may also determine an insertion type.

As an example of the insertion type, an area in which an image is to be inserted may be segmented based on the number of images and each image may be inserted in a corresponding area.

Also, as another example, a portion of images may be inserted on the front surface of an image output and a remaining image may be inserted on the rear surface of the image output. Also, an image not directly captured may be output by inserting, for example, a movie poster or related information on a specific area of a specific surface.

After selecting the insertion type and the image to be inserted, the user needs to determine an output type. That is, the user needs to select a type of the image output.

For example, a type of the image output may include a plastic card, paper, thermal image paper, and a lenticular card, and, without being limited thereto, may include any type of materials capable of inserting and thereby outputting an image. Also, the image output may be provided in a mobile content form as well as in a physical output form. In the case of selecting a lenticular card type, the plurality of images may be viewed according to a viewing angle.

For example, based on a point at which an angle between the plane of the image output and a line of sight is vertical, an image to which AR content is not applied may be viewed when viewed from a left angle and an image to which the AR content is applied may be viewed when viewed from a right angle.

As another example, an image captured by the user may be viewed when viewed from a left angle and movie poster or related information may be viewed when viewed from a right angle. If the example embodiment is applied, a ticket may not simply serve as an admission ticket. That is, advertising effect may be maximized by motivating the user to keep the ticket.

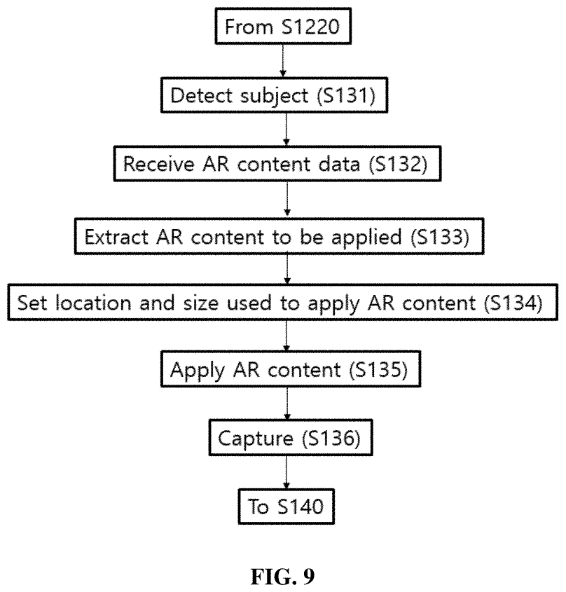

FIG. 9 is a flowchart illustrating an example of an operation of performing capturing by applying AR content in the method of producing the AR-based image output according to an example embodiment.

Referring to FIG. 9, operation S130 includes operation S131 of detecting, by the image production device 100, a subject, operation S132 of receiving, by the image production device 100, AR content data, operation S133 of extracting, by the image production device 100, AR content to be applied to an image to be captured, operation S134 of setting, by the image production device 100, a location and a size used to apply the AR content, operation S135 of applying, by the image production device 100, the AR content to the image to be captured, and operation S136 of capturing, by the image production device 100, the image displayed on a shooting screen.

Operation S131 refers to an operation in which the image production device 100 detects the subject that is specified through the sensor unit 120 in operation S120, through face alignment technology.

Operation S132 refers to an operation in which the image production device 100 receives an AR content data stored in the server 200 from the server 200.

The server 200 stores and manages the AR content database. According to another example embodiment, the AR content database may be prestored in the image production device 100 itself.

Operation S133 refers to an operation in which the image production device 100 extracts suitable content from the AR content database received from the server 200 based on information input from the user, such as, for example, the number of users, ticket information, viewing information, and reservation information.

According to an example embodiment, the AR content database may be grouped and stored for each movie. When a user requests an image output production request after viewing a specific movie and inputting ticket information, the image production device 100 extracts an AR content database related to the specific movie.

Content to be applied to a face of the user may be stored in the AR content database for each movie character. Content to be applied to the face may be stored for each capturing direction, such as front, side, and the like. In addition, a variety of content to be applied to a body part in addition to the face of the user may be stored to be applied for each gesture of the user. For example, AR content that matches each gesture of the user may be stored, such as when the user takes a palm open motion, when the user makes a V shape and a heart shape with fingers, and the like.

The image production device 100 may analyze a gesture and a capturing direction of the subject. Although the AR content recommendation module 213 automatically matches and recommends optimal AR content based on analysis information, the image production device 100 may suggest and apply AR content that matches the gesture of the subject and may apply the AR content by distinguishing the capturing direction of the subject into the front and the rear.

Through this, the user may verify that AR content related to a movie viewed by the user is automatically applied to an image to be captured and may also verify that different content is applied to the image to be captured every time the user takes a specific gesture. Therefore, a more interesting image output may be produced.

Operation S134 refers to an operation in which the image production device 100 sets a location and a size used to apply the AR content in a body part of the subject detected in operation S131.

AR content may be applied to a body part including a face of the subject. The sensor unit 120 of the image production device 100 recognizes and tracks the body part of the subject based on feature information of the subject stored in the server 200 and sets a location at which the AR content is to be applied.

The body part of the subject set as the location at which the AR content is to be applied may have various sizes depending on a distance from the capturing unit 140. Therefore, a size of the AR content may be automatically adjusted in proportion to an area of the corresponding body part of the subject displayed on the shooting screen. Therefore, it is possible to prevent excessively large or small AR content from being applied to the image to be captured and thereby prevent the image to be captured from becoming unnatural.

Operation S135 refers to an operation in which the image production device 100 applies the AR content extracted in operation S133 to the image to be captured based on the location and the size set in operation S134.

The AR content may be overlappingly applied to the subject displayed on the shooting screen and may also be applied around the body part of the subject.

Operation S136 refers to an operation in which the image production device 100 captures and stores the image to be captured through the capturing unit 140.

According to an example embodiment, in operation S136, a plurality of images may be captured. For example, the plurality of images to be captured may include an image being displayed on the shooting screen. Here, an image in which AR content is applied to the subject may be captured. As another example, an image that is an original appearance of the subject to which the AR content is not applied may be captured.

Through this, although it appears as if capturing is performed once, images before and after applying the AR content may be captured in practice. The plurality of images may be used in the following operation S140 of outputting the image output. The user may produce the image output using various combinations.

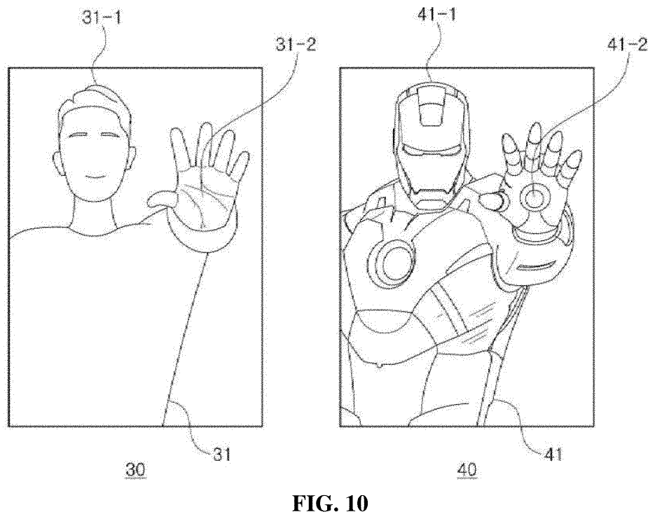

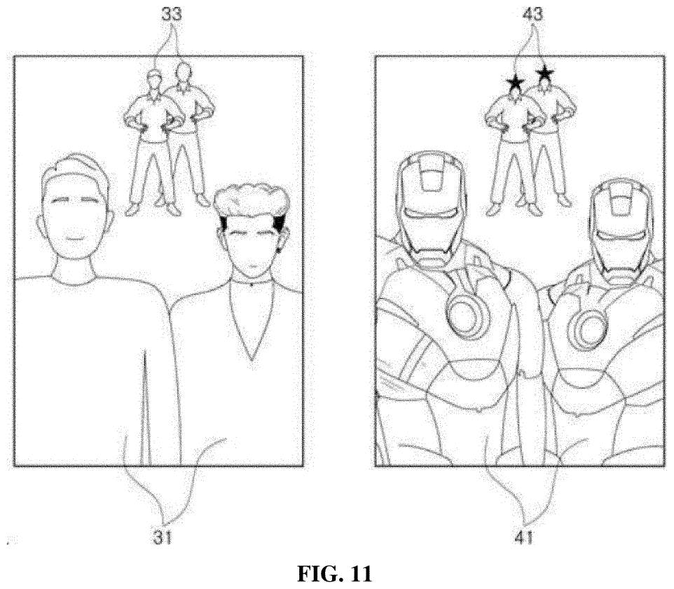

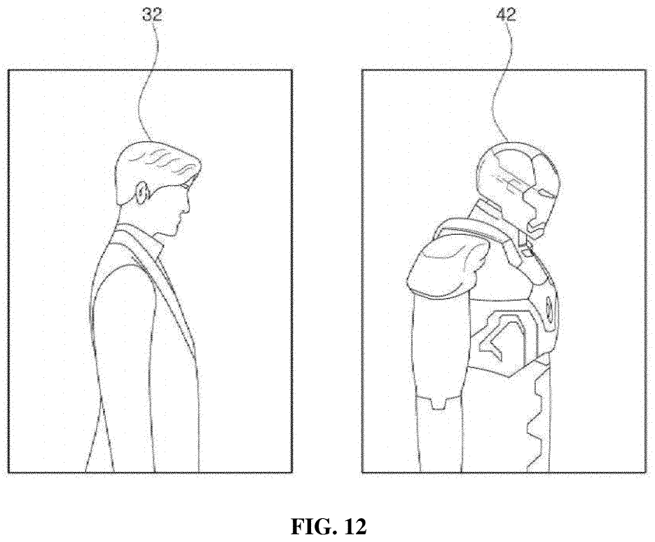

FIG. 10 illustrates examples of images before and after applying AR content according to an example embodiment.

Referring to FIG. 10, according to an example embodiment, an image 30 before applying AR content and an image 40 after applying the AR content may be verified.

Referring to the image 30 before applying the AR content, a body part of a user may be divided into various portions and detected through the sensor unit 120. For example, a face 31-1 of a subject that is an entity 31 to be captured and a hand 31-2 of the subject may be detected.

Although FIG. 10 illustrates a face portion and a hand portion of the subject, any body part of the subject displayed on a shooting screen may be detected without being limited to the face portion and the hand portion.

A location and a size of the body part are detected.

In addition, for example, a motion and a shape of the hand 31-2 of the subject are detected. Therefore, different AR content may be applied according to a motion and a shape taken by the user.

Referring to the image 40 after applying the AR content, as different types of AR contents, respectively, in relation to the face 31-1 of the subject and the hand 31-2 of the subject, face-related AR content 41-1 is applied to the face portion and hand-related AR content 41-2 is applied to the hand portion. That is, an image output production device creates a subject 41 to which AR content is applied by extracting and applying different content from an AR content database according to a body part of the subject.

FIG. 11 illustrates examples of images to which AR content is applied when a plurality of subjects is present according to an example embodiment.

Referring to FIG. 11, subjects displayed on a shooting screen include a third entity 33 irrelevant to capturing as well as a user that is the entity 31 to be captured.

When the third entity 33 irrelevant to the entity 31 to be captured is included in an image to be captured, a portrait right issue may occur. From perspective of the entity 31 to be captured, a satisfaction for a captured image may be degraded since an undesired target is included in the captured image.

To outperform the above issue, the example embodiment may differentially apply AR content, which is described above.

The example embodiment includes operation S120 of setting and storing the entity 31 to be captured through advance specification. AR content applied herein includes the main content 41 and the sub content 43.

The main content 41 refers to AR content that is applied to a subject specified as the entity 31 to be captured in the AR image processing module. In the aforementioned process, the applied AR content corresponds to the main content 41.

The sub content 43 refers to AR content that is applied to the third entity 33 irrelevant to the entity 31 to be captured, that is, a subject that is not specified in the AR image processing module.

An example of the sub content 43 includes perform blur-processing that is a representation scheme of processing an image to be out of focus or performing mosaic processing such that the third subject 33 may not be specified. Also, auxiliary AR content distinguished from the main content 41 may be applied.

For example, if the user has watched a movie in which a plurality of heroes appears, AR content related to a corresponding hero may be applied to the entity 31 to be captured as the main content 41 and AR content corresponding to an unimportant character or a background in the movie may be applied to the third entity 33.

As described above, according to an example embodiment, the entity 31 to be captured and the third entity 33 may be distinguishably recognized and differential AR content may be applied to each of the main content 41 and the sub content 43. Therefore, it is possible to prevent the third entity 33 from being included in the image to be captured as is.

According to an example embodiment, the image production device 100 may distinguish the entity 31 to be captured from the third entity 33 based on a screen occupation area. That is, the image production device 100 may recognize a subject that occupies an area with a specific size or more as the entity 31 to be captured and may determine a subject that occupies an area with a specific size or less in the background as the third entity 33. Through this, the image production device 100 may determine the number of subjects recognized based on an area and may distinguishably specify each of recognized at least one subject.

FIG. 12 illustrates examples of images before and after applying AR content when a capturing direction of a subject corresponds to a side view according to an example embodiment.

Referring to FIG. 12, it can be understood that a case in which the entity 31 to be captured is sideways may be recognized to be distinguished from a case in which the entity 31 to be captured faces the front relative to the capturing unit 140.

The sensor unit 120 of the image production device 100 distinguishably recognizes whether an appearance of the entity 31 to be captured corresponds to front or side. AR content that matches a recognized capturing direction is applied.

Referring to FIG. 12, a side appearance 32 of the face 31-1 of the entity 31 to be captured is recognized. AR content 42 corresponding to a side appearance of the face-related AR content 41-1 applied to the face 31-1 that is a front appearance of the entity 31 to be captured is applied.

Therefore, the user may capture an image to which various types of AR contents are applied according to a capturing direction, which makes it possible to produce various image outputs.

Hereinafter, operation S140 of outputting the image output by inserting the captured image is further described.

According to an example embodiment, a plurality of captured images including the image 30 before applying the AR content, the image 40 after applying the AR content, and images (32 and 42) captured in a side capturing direction may be created. In addition to such a captured image, information related to a movie or a performance that is the purpose of a ticket, such as a movie poster and movie information, may be inserted into an image output.

Examples of a method of combining the plurality of images and inserting the same into the image output include a method of segmenting one surface into respective areas and inserting each image into a corresponding area, a method of inserting a different image on each of a front surface and a rear surface of the image output, and a method of utilizing a lenticular film. However, it is provided as an example only.

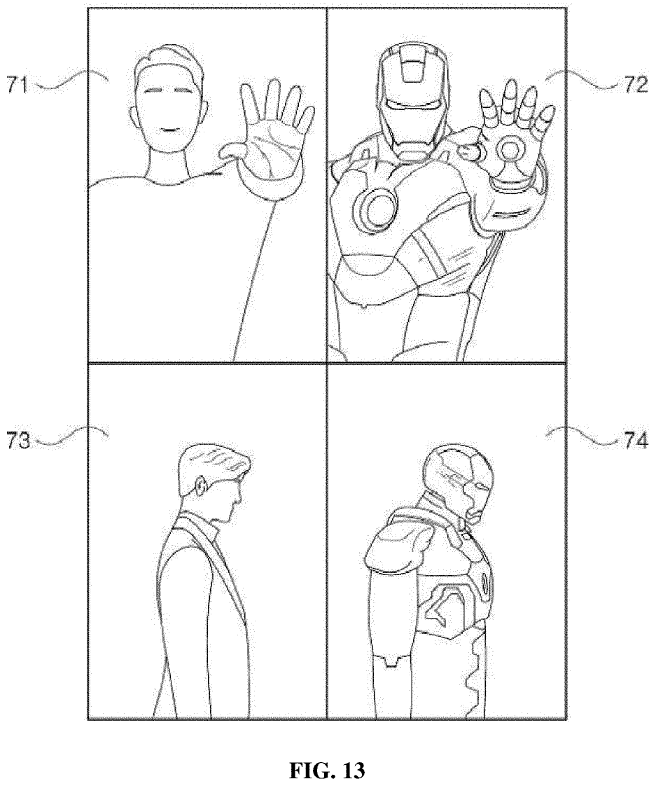

FIG. 13 illustrates an example of outputting images by inserting and combining a plurality of images in separate areas according to an example embodiment.

For image output production, the image production device 100 may create a plurality of images and may arrange the plurality of images on an output area in a distributed manner.

The created plurality of images may be inserted in segmented areas 71, 72, 73, and 74, respectively. A type and order of an image to be inserted may be readily selected by the user. Therefore, it is possible to produce the image output in a large number of cases.

For example, in the example of FIG. 13, an appearance before applying AR content to a front appearance of the entity 31 to be captured is inserted in the area 71, an appearance after applying the AR content to the front appearance of the entity 31 to be captured is inserted in the area 72, an appearance before applying the AR content to the side appearance 32 of the entity 31 to be captured is inserted in the area 73, and an appearance after applying the AR content to the side appearance 32 of the entity 31 to be captured is inserted in the area 74.

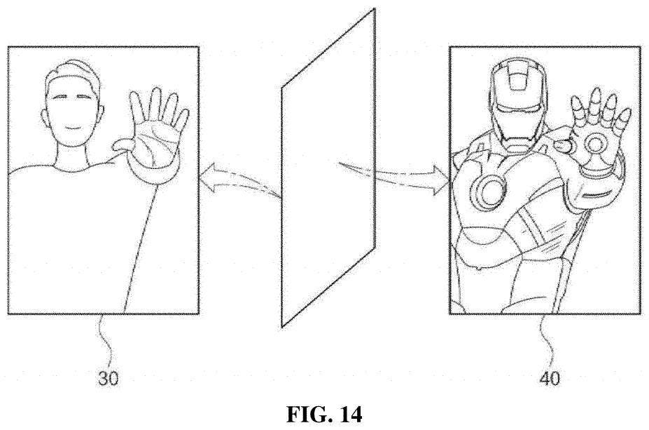

FIG. 14 illustrates an example of inserting images on a front surface and a rear surface of an image output, respectively, according to an example embodiment.

Referring to FIG. 14, the image output may be produced by inserting different images on a front surface and a rear surface of the image output, respectively.

For example, referring to FIG. 14, the image 30 before applying the AR content may be inserted on the front surface of the image output and the image 40 after applying the AR content may be inserted on the rear surface of the image output.

In addition, a method of inserting one of captured images on the front surface and inserting movie poster and movie information on the rear surface may be applied. Various methods may be readily selected and applied based on preference of the user.

Operations of the described methods or algorithms according to the example embodiments may be directly implemented as hardware, may be implemented as a software module executed by hardware, or may be implemented through combination thereof. The software module may include a random access memory (RAM), a read only memory (ROM), an erasable programmable ROM (EPROM), an electrically erasable programmable ROM (EEPROM), a flash memory, a hard disk, a detachable disk, a CD-ROM, or any known computer-readable record medium to which the disclosure pertains.

Although a number of example embodiments have been described above, it will be apparent to one of ordinary skill in the art that various alterations and modifications in form and details may be made in these example embodiments without departing from the spirit and scope of the claims and their equivalents. For example, suitable results may be achieved if the described techniques are performed in a different order and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A content utilization platform system comprising:
a server configured to extract augmented reality (AR) content based on at least one of the number of users, ticket information, viewing information, reservation information, and a subject image, to provide the extracted AR content to an image production device, to receive an image produced by the image production device from the image production device, and to provide a virtual space using the produced image to a user terminal;
the image production device configured to produce and output an image output by applying AR content to a captured subject; and
the user terminal configured to connect to the virtual space provided from the server.

2. The content utilization platform system of claim 1, wherein the server comprises at least one of:
an AR content provider configured to provide AR content to the image production device;
a virtual space provider configured to provide the virtual space accessible by a user to the user terminal;
a user database configured to store and manage at least one of user information and an authentication code;
a payment unit configured to perform a payment from the user;
a survey manager configured to request at least one of the image production device and the user terminal for survey;
an event manager configured to provide a coupon and a product to at least one of the image production device and the user terminal; and
a communicator configured to perform at least one of wired communication and wireless communication with the image production device and the user terminal.

3. The content utilization platform system of claim 2, wherein the AR content provider comprises at least one of:
an AR database configured to store and manage AR content provided from at least one of a content creator and the user; and
an AR content recommender configured to extract AR content based on at least one of the number of users, ticket information, viewing information, reservation information, and a subject image, and to provide the extracted AR content to the image production device.

4. The content utilization platform system of claim 3, wherein the AR content recommender is configured to provide an additional AR image according to a motion and a gesture of a subject recognized by a motion recognition sensor.

5. The content utilization platform system of claim 2, wherein the virtual space provider comprises at least one of:
a quiz field that enables at least one user connected to the virtual space to solve a quiz and receive a corresponding reward;
an item field that enables the user connected to the virtual space to purchase at least one of an item and a product related to content; and
an actor field that enables the user connected to the virtual space to communicate with a content-related person or to view an image or a video provided from the content-related person.

6. The content utilization platform system of claim 1, wherein the image production device comprises at least one of:
a communicator configured to perform at least one of wired communication and wireless communication with the server;
a sensor unit configured to recognize a subject;
an input unit configured to receive information and a request from a user;
a capturing unit configured to capture the subject;
a display unit configured to display a shooting screen and an output screen on which the subject and AR content appear; and
an output unit configured to produce and output an image output by inserting an image captured by applying the AR content.

7. The content utilization platform system of claim 6, wherein the sensor unit comprises at least one of:
a human body sensor configured to recognize approach of the subject; and
a motion recognition sensor configured to recognize a motion and a gesture of the subject.

8. The content utilization platform system of claim 6, wherein the image production device is configured to:
set a subject to be captured among subjects detected through the sensor unit,
extract AR content from a database based on at least one of the number of users, ticket information, viewing information, and reservation information,
analyze a gesture and a capturing direction of the subject to be captured, apply AR content that matches the gesture of the subject to be captured based on an analysis result in consideration of the capturing direction of the corresponding subject, and provide the same to the shooting screen,
produce and output an image output by inserting an image captured by applying AR content selected from the user,
extract a landmark feature point related to a body part including a face and a hand of the subject to be captured, recognize and track the subject to be captured in real time based on the landmark feature point, and automatically adjust a size of the AR content based on a size of the subject to be captured,
in response to the user viewing a specific movie and inputting ticket information, extract AR content related to the specific movie,
automatically match and recommend AR content based on subject analysis information including at least one of a location, a facial expression, and a gesture of the subject to be captured,
in response to applying the AR content related to the specific movie to the subject to be captured, apply AR content corresponding to a character or a background screen of the specific movie to a subject to not be captured among the subjects detected through the sensor unit, and
distinguish the subject to be captured from the subject to not be captured based on a screen occupation area.

9. The content utilization platform system of claim 1, wherein the user terminal comprises at least one of:
a communicator configured to perform at least one of wired communication and wireless communication with the server;
an input unit configured to receive information and request from a user;
a user content provider configured to provide AR content produced by the user to the server; and
a display unit configured to display the virtual space and contents required for communication with the server.

10. A method of producing an augmented reality (AR)-based image output using an image production device configured to produce an image output in the content utilization platform system of claim 1, the method comprising
initiating capturing;
setting a subject to be captured among subjects detected through a sensor unit;
extracting AR content from a database based on at least one of the number of users, ticket information, viewing information, and reservation information;
analyzing a gesture and a capturing direction of the subject to be captured, applying AR content that matches the gesture of the subject to be captured based on an analysis result in consideration of the capturing direction of the corresponding subject, and providing the same to a shooting screen; and
producing and outputting an image output by inserting an image captured by applying AR content selected from a user,
wherein the providing to the shooting screen comprises:
extracting a landmark feature point related to a body part including a face and a hand of the subject to be captured, recognizing and tracking the subject to be captured in real time based on the landmark feature point, and automatically adjusting a size of the AR content based on a size of the subject to be captured;
in response to the user viewing a specific movie and inputting ticket information, extracting AR content related to the specific movie;
automatically matching and recommending AR content based on subject analysis information including at least one of a location, a facial expression, and a gesture of the subject to be captured;
in response to applying the AR content related to the specific movie to the subject to be captured, applying AR content corresponding to a character or a background screen of the specific movie to a subject to not be captured among the subjects detected through the sensor unit; and
distinguishing the subject to be captured from the subject to not be captured based on a screen occupation area.

11. The method of claim 10, wherein the initiating of the capturing comprises:
in response to recognizing a random subject by a specific size or more in a capturing area, displaying a screen on which AR content is applied to the random subject and outputting a sound.

12. The method of claim 10, wherein the extracting of the AR content comprises recognizing and analyzing an age, a gender, a facial expression, and a gesture of a subject by applying artificial intelligence (AI) technology based on a pretrained database, and automatically matching and recommending AR content based on an analysis result.

13. The method of claim 10, wherein the producing and outputting of the image output comprises:
creating a plurality of images;
distributing the plurality of images on an output area; and
setting a type of the image output.
